(19) United States
(12) Patent Application Publication
(10) Pub. No.: US 2023/0092638 A1
(43) Pub. Date: Mar. 23, 2023

(54) DELIVERY MANAGEMENT DEVICE, DELIVERY MANAGEMENT METHOD, AND STORAGE MEDIUM

(71) Applicant: NEC Corporation, Minato-ku, Tokyo (JP)

(72) Inventors: Kei Shibuya, Tokyo (JP); Kan Arai, Tokyo (JP); Azusa Furukawa, Tokyo (JP); Makiko Akiguchi, Tokyo (JP); Hiroshi Hashimoto, Tokyo (JP); Ken Hanazawa, Tokyo (JP)

(73) Assignee: NEC Corporation, Minato-ku, Tokyo (JP)

(21) Appl. No.: 17/801,855

(22) PCT Filed: Mar. 19, 2020
(86) PCT No.: PCT/JP2020/012168

§ 371 Date: Aug. 24, 2022

(51) Int. Cl. G06Q 10/0639; G06V 20/52; G06T 7/73; G06T 7/00

(52) U.S. Cl. CPC G06Q 10/06398; G06V 20/52; G06T 7/73; G06T 7/0002; G06T 2207/30232; G06T 2207/30242

(57) ABSTRACT

Provided is a delivery management device for determining the delivery skill of a worker who delivers products in a specific store such as a labor-saving store.

A delivery management device 30 equipped with an authentication unit 31 for authenticating a deliverer of a product on the basis of a captured image, and a skill determination unit 32 for determining the skill of the deliverer by using skill information which includes one or more elements among the number of products displayed, the time required by displaying and the product display state level on the product shelf, which are calculated on the basis of an image in which the authenticated deliverer displays one or more products on a product shelf.

### TECHNICAL FIELD

The present invention relates to a delivery management device and the like for managing delivery by a worker.

### BACKGROUND ART

The retail industry needs inventory management of products in stores in order to reduce opportunity loss. As a method of inventory management, PTL 1 discloses a technique for resolving inventory deviation of products among a plurality of stores.

### CITATION LIST

### Patent Literature

[PTL 1] JP 2009-217377 A

### SUMMARY OF INVENTION

### Technical Problem

However, PTL 1 described above discloses an inventory management method of a regular store where a worker is resident, but does not disclose a technique of managing the inventory of a labor-saving store or the like where there is no worker monitoring the inventory of products, particularly, a method of determining a delivery skill when a worker of a labor-saving store or the like delivers products.

One object of the present disclosure is to solve the above-described problem and to provide a delivery management device for determining the delivery skill of a worker who delivers products in a specific store such as a labor-saving store.

### Solution to Problem

A delivery management device according to one aspect of the present disclosure includes:

an authentication means configured to authenticate a deliverer of a product based on a captured image; and

a skill determination means configured to determine a skill of the deliverer by using skill information that includes one or more elements among a number of the products displayed, time required for displaying the products, and a product display state level on a product shelf, which are calculated based on an image in which the deliverer having been authenticated displays one or more products on the product shelf.

A delivery management method according to one aspect of the present disclosure includes:

authenticating a deliverer of a product based on a captured image; and

determining a skill of the deliverer by using skill information that includes one or more elements among a number of the products displayed, time required for displaying the products, and a product display state level on a product shelf, which are calculated based on an image in which the deliverer having been authenticated displays one or more products on the product shelf.

A program according to one aspect of the present disclosure causes a computer to execute:

authenticating a deliverer of a product based on a captured image; and

determining a skill of the deliverer by using skill information that includes one or more elements among a number of the products displayed, time required for displaying the products, and a product display state level on a product shelf, which are calculated based on an image in which the deliverer having been authenticated displays one or more products on the product shelf.

The program may be stored in a non-transitory computer-readable recording medium.

### Advantageous Effects of Invention

An effect of the present disclosure is capability of providing a delivery management device or the like that can determine delivery skills of workers who deliver products in specific stores such as labor-saving stores.

### BRIEF DESCRIPTION OF DRAWINGS

FIG. 1 is a block diagram illustrating a configuration of an inventory management system in a first example embodiment.

FIG. 2 is a view illustrating an example of a relationship among stores in the first example embodiment.

FIG. 3 is a view illustrating an example of a positional relationship among a deliverer, a product, and a product shelf captured by a camera.

FIG. 4 is a flowchart illustrating an example of an operation of a delivery management device according to the first example embodiment.

FIG. 5 is a block diagram illustrating a configuration of an inventory management system in a second example embodiment.

FIG. 6 is a flowchart illustrating an example of an operation of a delivery management device according to a third example embodiment.

FIG. 7 is a block diagram illustrating a system configuration of the delivery management device according to the third example embodiment.

FIG. 8 is a block diagram illustrating an example of a hardware configuration of a computer.

### EXAMPLE EMBODIMENT

In the retail industry, introduction of labor-saving or unmanned stores (hereinafter, these are collectively referred to as “labor-saving stores”) has been promoted, for the purpose of improving operation efficiency and expanding to small trading areas. The labor-saving or unmanned stores reduce work of workers related to registration and settlement of purchased products, customer service support, in-store monitoring, delivery management, facility management, and the like, and reduce the number of, or eliminates, resident workers, for example, by a computer system.

In general, a labor-saving store is smaller in scale than a regular store, and has a limited sales floor space. Unlike regular stores placed along public roads in urban areas and suburban areas, these labor-saving stores are sometimes also placed in specific places such as office buildings, factories, stations, hotels, and collective houses. For example, a store (for example, so-called micro store) in which a product shelf is installed at a corner of a place other than a general store such as an office is also included in the labor-saving store.

Even in such a labor-saving store, inventory management and delivery management of products in the store are necessary in order to reduce sales opportunity loss. That is, the labor-saving store or the like needs a technique for causing a worker of a regular store or a worker dedicated to a labor-saving store to perform inventory management and delivery management, and monitoring and evaluating a state of it. Furthermore, if the display state of the products displayed on the product shelf by the worker in the labor-saving store is incomplete, that is, the display of the products is disorganized or products are insufficient, opportunity loss occurs, and this opportunity loss affects the sales of the labor-saving store. However, it is difficult to manage delivery such as display of products by a worker in a labor-saving store because there is none who monitors in the labor-saving store. Therefore, in the following example embodiments, a delivery management device or the like for managing delivery of a product by a worker in a labor-saving store, particularly for determining delivery skills of a worker who delivers the product will be described.

Example embodiments will be described below in detail with reference to the drawings. In the drawings and the example embodiments described in the description, same components are given the same reference signs, and the description will be omitted as appropriate.

### FIRST EXAMPLE EMBODIMENT

The first example embodiment will be described.

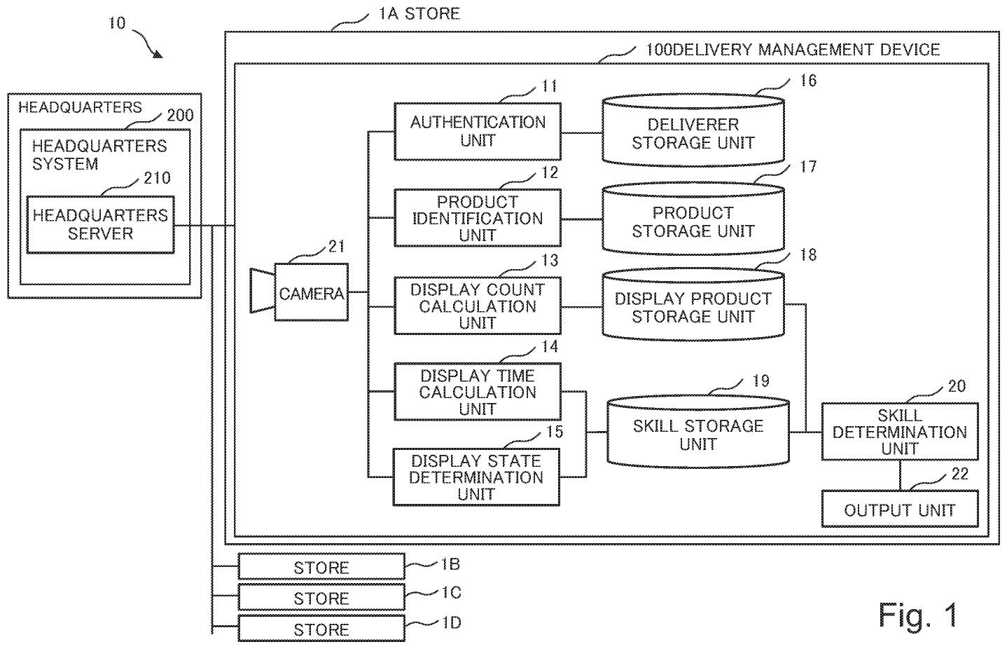

First, the configuration of the delivery management system of the first example embodiment will be described. FIG. 1 is a block diagram illustrating the configuration of an inventory management system 10 of the first example embodiment. With reference to FIG. 1, the inventory management system 10 includes a plurality of delivery management devices 100 and a headquarters system 200. For example, the delivery management device 100 is installed in each of labor-saving stores 1A, 1B, and 1C (hereinafter, collectively referred also to as store 1) such as convenience store or supermarket franchising in the retail industry. The headquarters system 200 is installed in the headquarters of the franchiser, for example. The delivery management device 100 of each store 1 and the headquarters system 200 are connected by a communication network, for example. The headquarters system 200 includes a headquarters server 210, and the headquarters server 210 performs product management, inventory management, and the like of the entire stores. The headquarters server 210 receives skills of a deliverer determined by the delivery management device 100. Based on an image (including a moving image and a still image. The same applies hereinafter.) of delivery work of a worker in the store 1 captured by a camera or the like, the delivery management device 100 determines skills of each worker based on accuracy of displaying products, time from start to completion of the displaying products, a cleaning state around a product shelf, and the like. The delivery management device 100 may transmit, to the headquarters server 210, information for determining skills of each worker, such as the accuracy of displaying products, the time from start to completion of the displaying products, and a cleaning state around a product shelf, and determine the skills on the headquarters server 210 side. The headquarters server 210 may determine the salary, promotion, other treatment, and the like of the worker based on the received skills.

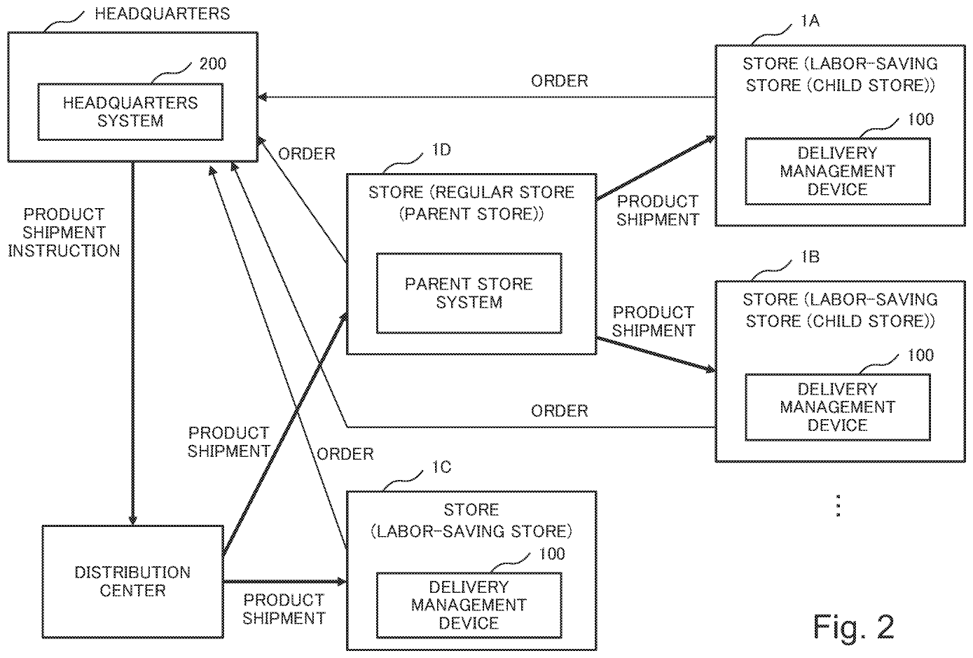

FIG. 2 illustrates an example of the relationship among the stores 1 in the first example embodiment. The labor-saving store is a store in which, in the franchise or the like, a computer system, for example, reduces at least a part of work of workers related to registration and settlement of purchased products, customer service support, in-store monitoring, delivery management, facility management, and the like as compared with a regular store. The sales floor space of the labor-saving store may be smaller than that of the regular store.

The labor-saving stores 1A and 1B may be managed by a regular store 1D nearby, or may exist independently like the labor-saving store 1C. The regular store that manages a labor-saving store is called a parent store (hereinafter, also referred to as “regular store (parent store)”), and the labor-saving store managed by a parent store is called a child store (hereinafter, also referred to as “labor-saving store (child store)”). The regular store (parent store) and the labor-saving store (child store) may be placed on different floors or the like in the same building, or may be placed in different nearby buildings.

The headquarters system 200 transmits, to a distribution center or the like, a delivery instruction of a product to be delivered to a store. The distribution center or the like delivers the product instructed by the headquarters system 200 to each of the stores 1. Here, the product of the labor-saving store (child store) is once delivered to the regular store (parent store) together with the product of the regular store (parent store). Then, the product of the labor-saving store (child store) is delivered from the regular store (parent store) to the labor-saving store (child store) by a worker or the like of the regular store (parent store), for example. The delivery management device 100 of a regular store or a labor-saving store may place an order, to the headquarters system 200, products to be replenished in inventory to the own store.

For example, a worker of the regular store (parent store) stays in each of the labor-saving stores (child stores) 1A and 1B when necessary for stocking delivered products, cleaning the store, maintenance of equipment, and replenishment and collection of cash. The labor-saving store (child store) may be a store in which a minimum number of workers are resident, or may be an unmanned store in which no worker is present in some time slots (no worker is resident).

The independent labor-saving store 1C may be managed by the headquarters instead of the parent store. The product of the labor-saving store 1C may be directly delivered from the distribution center to the labor-saving store 1C.

In the example of FIG. 2, the stores 1A and 1B are labor-saving stores (child stores), the store 1D is a regular store (parent store), and the store 1C is an independent labor-saving store. However, the present invention is not limited to this, and the stores 1A to 1D may be labor-saving stores.

With reference to FIG. 1 again, the delivery management device 100 includes an authentication unit 11, a product identification unit 12, a display count calculation unit 13, a display time calculation unit 14, a display state determination unit 15, a deliverer storage unit 16, a product storage unit 17, a display product storage unit 18, a skill storage unit 19, a skill determination unit 20, a camera 21, and an output unit 22. The delivery management device 100 may include a point of sale (POS) device (not illustrated) or the like for product settlement by customers themselves. In addition to that, a container for placing the money for the price of the product purchased by a customer may be included.

The deliverer storage unit 16 stores information for authenticating a worker (hereinafter, described as deliverer) to deliver, for example, feature data of the face of the deliverer, feature data of the iris, and the like.

The product storage unit 17 stores information for identifying product, for example, feature data of the appearance of the product. The product storage unit 17 may store a product ID and name, a product description, an amount of money for the product, and the like.

The display product storage unit 18 stores, as display product information, products displayed on the product shelf and the number of the products (for example, ten packs of chewing gum A and three pieces of bread B) determined based on the video captured by the camera 21.

The skill storage unit 19 stores the set time required for delivery by the deliverer calculated by the display time calculation unit 14 and the display state level of the product on the product shelf determined by the display state determination unit 15. The display state level is determined on values from level 1 to level 10, for example. Level 1 indicates that the display is in a very disorganized state, levels 2 to 9 indicate orderliness of the display state in ascending order, and level 10 indicates that the display is in a very orderly state. The display state level may be determined using a machine learning model learned based on an image of products displayed on a product shelf. The display state level may be determined by the skill determination unit 20 described later, including not only the state of the product in the product shelf but also additional conditions such as whether dust is not present around the product shelf and whether the product shelf is not broken.

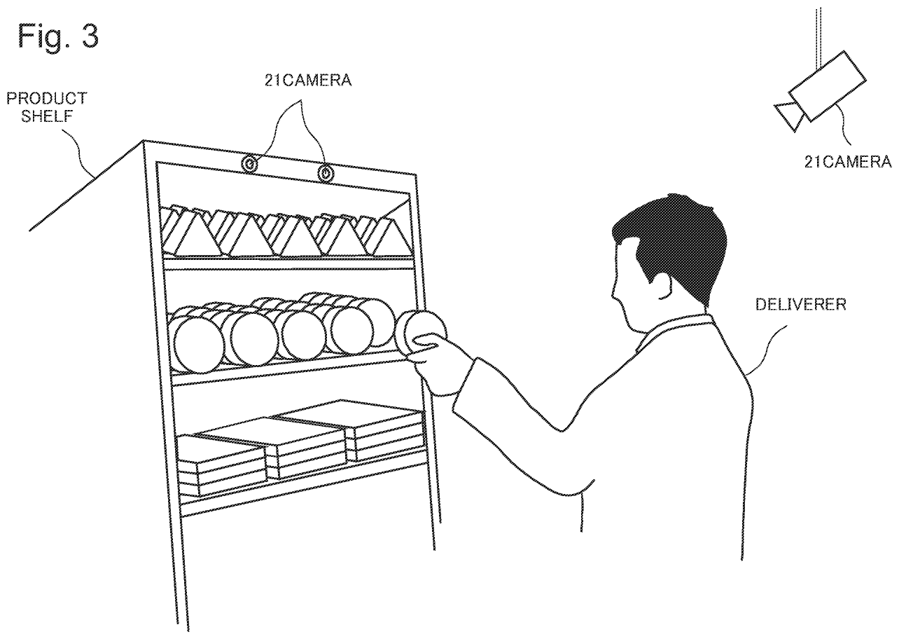

The camera 21 captures the product shelf and the worker. The camera 21 may capture the surroundings of the product shelf or a customer who takes out a product from the product shelf. As illustrated in FIG. 3, there may be a plurality of the cameras 21, and the product shelf and the worker may be captured from multiple directions. The product shelf is a place for placing products. The worker displays, on the product shelf, the delivered products, and the camera 21 captures the state of it. The camera 21 may capture an image of the worker for authentication, and may further capture an image of the worker displaying products on the product shelf. That is, the authentication image and the image of displaying may be acquired from the same resource (camera 21). Conversely, a camera that captures an image for authentication of the worker may be provided separately. For the authentication of the worker, an authentication method (for example, fingerprint authentication, voiceprint authentication, ear authentication, and the like) other than the image captured by the camera may be used. Video and images captured by the camera 21 are transmitted to the authentication unit 11, the product identification unit 12, the display count calculation unit 13, the display time calculation unit 14, and the display state determination unit 15.

The authentication unit 11 authenticates the deliverer of the product based on the image captured by the camera 21. Since the persons captured by the camera 21 include a customer, a passer-by, and a deliverer, the authentication unit 11 authenticates only the deliverer from among a large number of persons. The authentication unit 11 extracts feature data from a face image, an iris image, and the like of the deliverer captured by the camera 21, compares the extracted feature data with feature data of a face image, an iris image, and the like stored in the deliverer storage unit 16, and authenticates the deliverer in a case of a matching degree exceeding a predetermined threshold. For example, in the comparison, the authentication unit 11 calculates the matching degree between the extracted feature data and the feature data stored in the deliverer storage unit 16. The matching degree is a numerical value indicating a degree of matching of feature data, and is a ratio or a level of matching. As a result of calculation of the matching degree, in a case where the matching degree exceeding the predetermined threshold is obtained, the authentication unit 11 authenticates the deliverer. In the authentication of the deliverer of the product, the authentication unit 11 may perform both the face authentication and the iris authentication, or may perform either of them. The authentication unit 11 outputs information on the authenticated deliverer to the display time calculation unit 14 and the display state determination unit 15. The information on the deliverer is information that can individually identify the deliverer, for example, identification information for identifying the deliverer. When the authentication unit 11 authenticates the deliverer, the delivery management device 100 monitors the product management work by the worker who is the deliverer.

Based on the image acquired from the camera 21, the product identification unit 12 identifies individual information (feature data of the product package and the like) of each of one or more products displayed on the product shelf. Specifically, the product identification unit 12 extracts the feature data of appearance of the product from the products included in the image, compares the extracted feature data with the feature data of the products stored in the product storage unit 17, and identifies the product as a predetermined product in a case of a matching degree (for example, 99% match) exceeding a predetermined threshold. The product identification unit 12 outputs information on the identified product to the display count calculation unit 13, the display time calculation unit 14, and the display state determination unit 15. The information on the identified product is, for example, a product ID and name, and feature data of the product.

The display count calculation unit 13 calculates the number of one or more displayed products based on the image acquired from the camera 21. Specifically, the display count calculation unit 13 calculates how many products identified by the product identification unit 12 being included in the image. That is, the display count calculation unit 13 calculates the total of the types of products displayed on the product shelf using the information on the products identified by the product identification unit 12. In a case where a plurality of types of products identified by the product identification unit 12 are included in the image, the display count calculation unit 13 detects, by identifying the product from the image using the feature data of the product, the individual display number indicating how many products being displayed in the display direction for each product displayed in the display direction. Next, the display count calculation unit 13 calculates the detected individual display number for all displayed products (for example, ten packs of chewing gum A and five pieces of bread B). The number of each displayed product calculated by the display count calculation unit 13 is stored in the display product storage unit 18 as display product information.

Based on the image acquired from the camera 21, the display time calculation unit 14 calculates the time required from start to end of displaying one or more products completed by the deliverer, that is, the time required for the display. Upon acquiring the information on the deliverer from the authentication unit 11, the display time calculation unit 14 uses a timer function such as an operating system (OS), a timer function, and the like to calculate, based on the image acquired from the camera 21, the time required from start to end of displaying the product completed by the deliverer. The display time calculation unit 14 identifies the deliverer associated to the information on the deliverer from the image, tracks the identified deliverer, and detects an operation of handling the product identified by the product identification unit 12. The display time calculation unit 14 detects, by the timer of the OS, the duration time of the operation by which the deliverer handles the product. Regarding detection of the above operation, a machine learning model for identifying an operation by which a person handles a product from an image may be used. The display time calculation unit 14 stores the time required for displaying in the skill storage unit 19.

Based on the image acquired from the camera 21, the display state determination unit 15 specifies the arrangement position of each of one or more products in the product shelf, and determines the display state level of the product in the product shelf using the specified arrangement position. The display state determination unit 15 receives the feature data of the product from the product identification unit 12, and specifies the arrangement position and posture of the product in the product shelf using the image recognition technology. The display state determination unit 15 senses which position in the image (image acquired from the camera 21) of the product shelf the product matching the feature data of the product is present, determines whether the product is arranged at an appropriate position of the product shelf, whether the posture of the product is correct (whether the products are arranged at equal intervals along the frame of the product shelf), and the like, and determines the display state level of the products in the product shelf. In this case, the determination may be made while the display count calculation unit 13 identifies, from the image using the feature data of the product, the individual display number indicating how many products being displayed in the display direction for each product displayed in the display direction. In this case, since the display state determination unit 15 cooperates with the display count calculation unit 13, the image acquired from the camera 21 becomes an image used in the display count calculation unit 13.

The display state determination unit 15 determines the display state level on values from level 1 to level 10, for example. The display state level may be determined using a machine learning model learned based on an image of products displayed on a product shelf. The display state level may be determined using a machine learning model of a neural network by deep learning that identifies the display state at each of the display state level 1 to the display state level 10 by inputting an image, for example. The display state determination unit 15 may determine the display state level including not only the state of the product in the product shelf but also additional conditions such as whether dust is not present around the product shelf and whether the product shelf is not broken. The display state determination unit 15 stores the display state level for each product in the skill storage unit 19.

The skill determination unit 20 determines the skill of the deliverer by using skill information which includes one or more elements among a number of the products displayed, time required for displaying, and a product display state level on a product shelf, which are calculated based on an image in which the deliverer displays one or more products on the product shelf. The image in which the deliverer is performing the work of displaying one or more products on the product shelf is an image in which the display time calculation unit 14 is in the middle of calculating time required from start to end of displaying one or more products completed by the deliverer based on the image acquired from the camera 21. The skill determination unit 20 acquires, for the product identified from the image, the number of each product displayed from the display product storage unit 18, and the time required for the deliverer to display the product and the display state level of the product on the product shelf from the skill storage unit 19. With the number of each acquired product, time required for displaying, and the display state level as parameters, the skill determination unit 20 inputs the parameters into a predetermined calculation formula, outputs a skill value, and determines the skill level of the deliverer based on the skill value. For example, the following calculation formula is used.

Skill value=total number of display/time required for displaying×display state level

Here, the total number of display is the total number of products multiplied by the number of display for each product, that is, the total number of products displayed on the product shelf. For example, when 5 pieces of a product A, 10 pieces of a product B, and 20 pieces of a product C are displayed by a certain deliverer, the total number of display is 35, which is the total sum. Assuming that the time required for the deliverer to display is 100 seconds and the display level of the deliverer is 5, the skill value is 1.75. For a skill value n, a skill m is an integer value satisfying n<m≤n+1. Since n=1.75 in the above example, m is determined to be 2 from 1.75<m≤2.75. Therefore, the skill determination unit 20 determines that the skill of the deliverer is 2. Since some products are easy and some are difficult to display (for example, a product having a shape that is easy to stack and a product having a shape that is easy to collapse when stacked), a weighting factor may be multiplied to products that are difficult to display. The skill determination unit 20 outputs the determined skill information to the output unit 22.

The output unit 22 outputs the skill information received from the skill determination unit 20. The output unit 22 may display the determined skill information by the skill determination unit 20 on a display (not illustrated) that can be viewed by the deliverer or may store the determined skill information in the skill storage unit 19. The output unit 22 may output the skill information to the outside, for example, a display included in the parent store system of the regular store (parent store) 1D or a display connected to the headquarters system 200. The headquarters system 200 may determine the salary, promotion, other treatment, and the like of the worker based on the output skill.

### Operation of Delivery Management Device

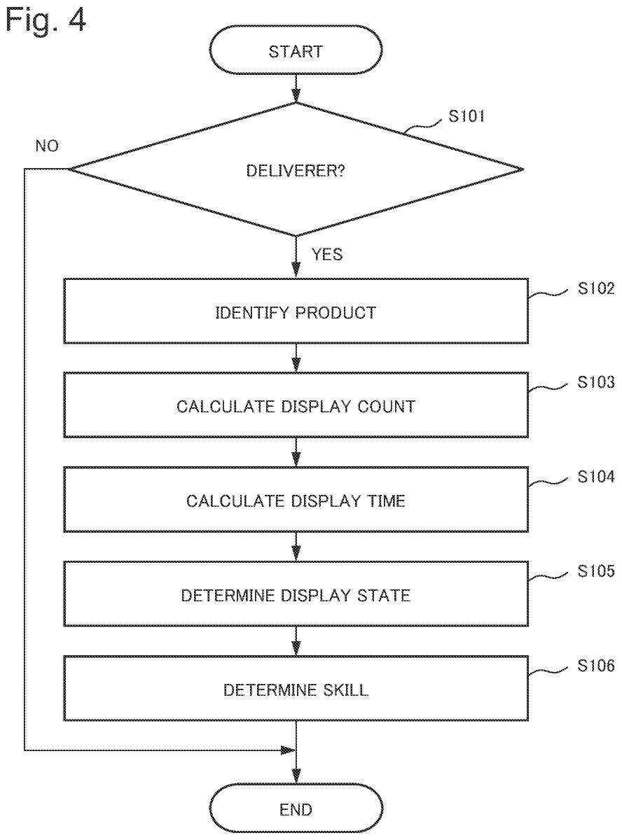

The operation of the delivery management device 100 will be described with reference to the flowchart illustrated in FIG. 4.

In step S101, the authentication unit 11 authenticates whether the person included in the image is a product deliverer based on the image captured by the camera 21. As a result of the authentication, if the deliverer is authenticated, the processing proceeds to step S102. As a result of the authentication, if the deliverer is not authenticated, the present processing is ended.

In step S102, based on the image, the product identification unit 12 identifies individual information of each of one or more displayed products, and transmits the identified information to the display count calculation unit 13, the display time calculation unit 14, and the display state determination unit 15.

In step S103, based on the image, the display count calculation unit 13 calculates the number of identified products that are displayed, and stores, in the skill storage unit 18, the calculated number of products.

In step S104, based on the above image, the display time calculation unit 14 calculates the time required from start to end of displaying the identified product completed by the deliverer, and stores the calculated time in the skill storage unit 19.

In step S105, based on the above image, the display state determination unit 15 specifies the arrangement position of each identified product in the product shelf. The display state determination unit 15 determines the display state level of the product on the product shelf using the specified arrangement position. The display state determination unit 15 stores the display state level of the determined product in the skill storage unit 19.

Steps S103 to S105 may be executed in a different order, or may be executed simultaneously.

In step S106, the skill determination unit 20 determines the skill of the deliverer by using the skill information including at least one of the number of displayed products acquired from the display product storage unit 18, the time required from start to end of displaying that is acquired from the skill storage unit 19, and the display state level of the product on the product shelf. The skill determination unit 20 outputs the determined skill to the output unit 22. The output unit 22 outputs the determined skill to an external device or the like.

### Effects of First Example Embodiment

According to the first example embodiment of the present disclosure, it is possible to determine the delivery skill of the worker who delivers the product in a specific store such as a labor-saving store. This is because, based on the captured image, the authentication unit 11 authenticates whether to be the deliverer of the product, and the skill determination unit 20 determines the skill of the deliverer using the skill information including at least one of the number of displayed products, the time required for displaying, and the display state level of the product on the product shelf calculated based on the image in which the authenticated deliverer displays one or more products on the product shelf.

### SECOND EXAMPLE EMBODIMENT

The second example embodiment will be described.

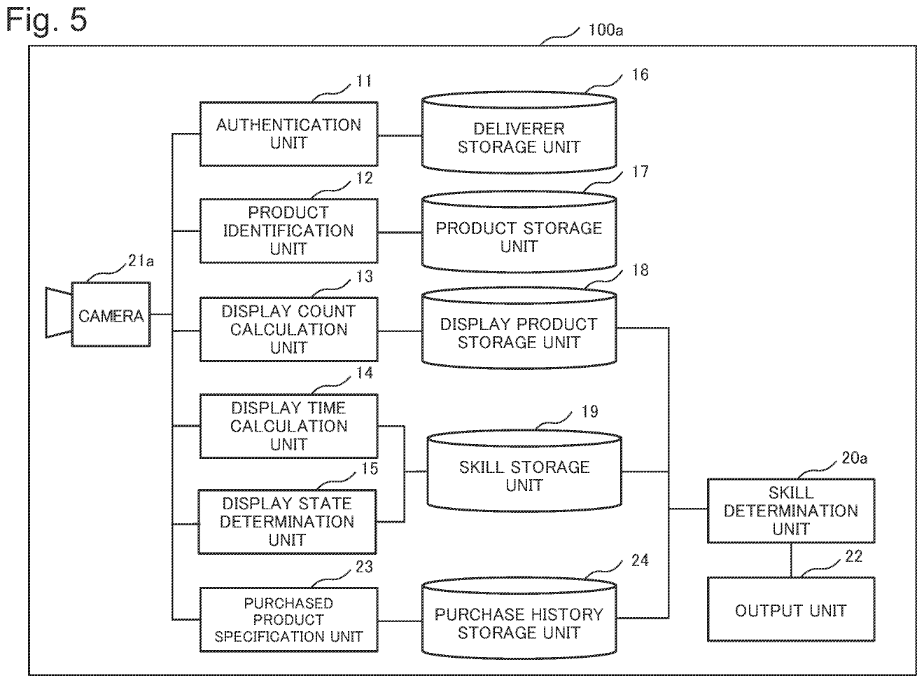

FIG. 5 illustrates a configuration example of a delivery management device 100a in the second example embodiment. The delivery management device 100a includes an authentication unit 11, a product identification unit 12, a display count calculation unit 13, a display time calculation unit 14, a display state determination unit 15, a deliverer storage unit 16, a product storage unit 17, a display product storage unit 18, a skill storage unit 19, a skill determination unit 20a, a camera 21a, a purchased product specification unit 23, and a purchase history storage unit 24.

The camera 21a is the same camera as the camera 21, but video and images captured by the camera 21a are transmitted to the authentication unit 11, the product identification unit 12, the display count calculation unit 13, the display time calculation unit 14, the display state determination unit 15, and the purchased product specification unit 23.

Based on the image received from the camera 21, the purchased product specification unit 23 specifies a purchased product among one or more displayed products, and specifies the number of the purchased products. The purchased product specification unit 23 acquires the amount of money for the product from the product storage unit 17, multiplies the number of products by the amount of money for each purchased product, and calculates a sales value of the purchased product. The purchased product specification unit 23 stores, in the purchase history storage unit 24, the purchased product, the number of sales of the product, and the sales value as purchase history data. The purchased product specification unit 23 may compare, using an image recognition processing technology, the first image in which the product immediately after display is displayed with the second image in which the purchased product is displayed, specify a difference between the first image and the second image as the purchased product, and specify the number of the product having been purchased. The purchased product specification unit 23 may receive individual information of each of the products displayed from the product identification unit 12 and the number of products displayed immediately after display and the number of products displayed after customer purchase from the display count calculation unit 13, and specify the purchased product and the number of products from the received individual information and the number of products immediately after display and after customer purchase.

The purchase history storage unit 24 stores the purchased product specified by the purchased product specification unit 23, the number of sales of the product, and the sales value.

The skill determination unit 20a determines the skill of the deliverer based on the skill information including the sales value of the product in addition to the number of displayed products acquired from the display product storage unit 18, the time required from start to end of displaying that is acquired from the skill storage unit 19, and the display state level of the product on the product shelf. The skill determination unit 20a acquires the sales value from the purchase history storage unit 24, and outputs an image in which one or more products are displayed on the product shelf based on the sales value. The skill determination unit 20a outputs, to the output unit 22, an image having a high sales value among the images displayed by the deliverer.

The other parts are the same as those of the first example embodiment, and the description will be omitted.

### Operation of Delivery Management Device

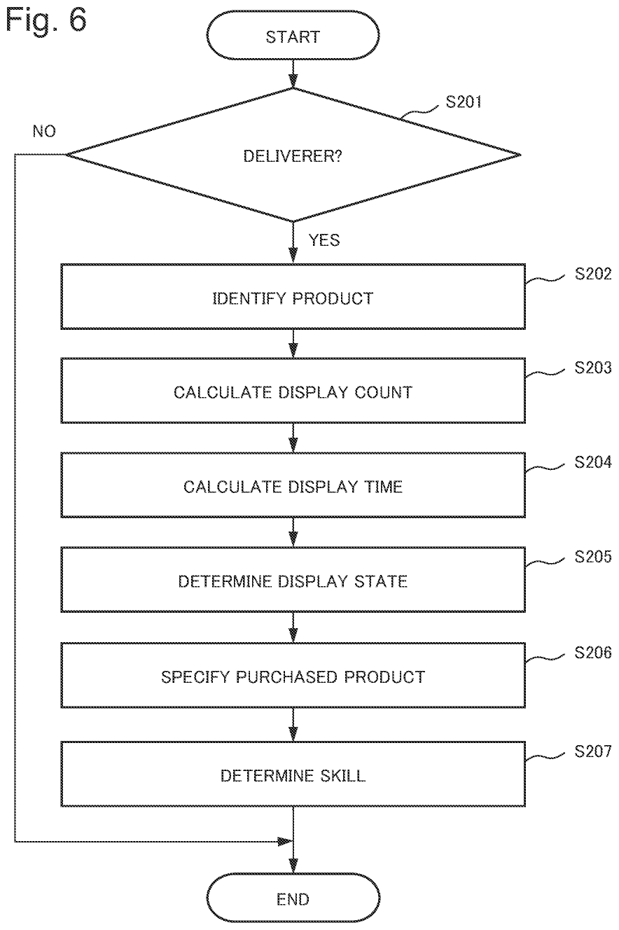

The operation of the delivery management device 100a will be described with reference to the flowchart illustrated in FIG. 6.

Steps S201 to S205 are similar to steps S101 to S105 illustrated in FIG. 4.

In step S206, based on the image received from the camera 21, the purchased product specification unit 23 specifies the purchased product among the one or more displayed products, specifies the number of the purchased products, and calculates the sales value of the purchased product. The purchased product, the number of sales of the product, and the sales value are transmitted to the skill determination unit 20a.

In step S207, the skill determination unit 20a determines the skill of the deliverer based on the skill information including the sales value of the product stored in the purchase history storage unit 24 in addition to the number of displayed products acquired from the display product storage unit 18, the time required from start to end of displaying that is acquired from the skill storage unit 19, and the display state level of the product on the product shelf. Based on the sales value, the skill determination unit 20a may output the image in which the products are displayed on the product shelf. The skill determination unit 20a may output, to the output unit 22, an image having a high sales value among the images displayed by the deliverer.

An effect of the second example embodiment will be described. According to the second example embodiment of the present disclosure, in addition to the effect of the first example embodiment, it is possible to more accurately determine the delivery skill of the worker who delivers the product. This is because the purchased product specification unit 23 specifies the purchased product among one or more products displayed based on the image received from the camera 21 and calculates the sales value of the purchased product, and the skill determination unit 20a determines the skill of the deliverer based on the skill information including the sales value.

As another effect, in the second example embodiment of the present disclosure, it is possible to transmit the skill of the deliverer with high sales to other deliverers. This is because, based on the sales value, the skill determination unit 20a outputs, to the output unit 22, the image in which one or more products are displayed on the product shelf. This is because the image of the product shelf of the deliverer with high sales having been output is also viewed by other deliverers via the output unit 22. By this, the product shelf with high sales can be used as a model, and the other deliverers can also make the product shelf with high sales.

In the above description, the deliverer performs only delivery of products, but the deliverer may be caused to select the type and the number of products to be delivered, that is, may be caused to perform inventory management. In a case where the deliverer performs inventory management and the sales increase, the skill determination unit 20a may determine the skill by including, as information for determining the skill of the deliverer, the fact that the sales increase due to the inventory management of the deliverer.

### THIRD EXAMPLE EMBODIMENT

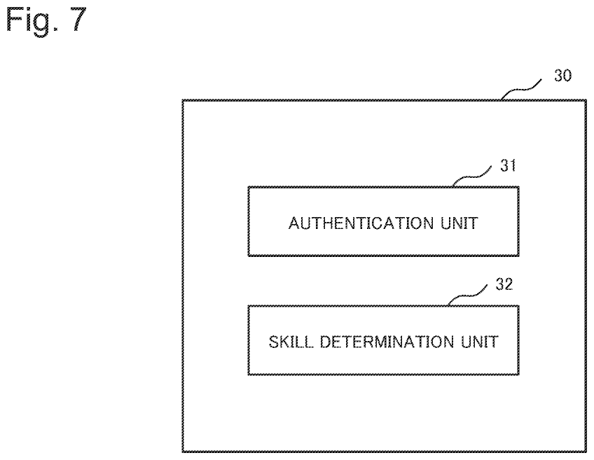

FIG. 7 illustrates a configuration example of a delivery management device 30 in the third example embodiment. The delivery management device 30 includes an authentication unit 31 and a skill determination unit 32.

The authentication unit 31 authenticates, based on the captured image, whether the person included in the captured image is a product deliverer.

The skill determination unit 32 determines the skill of the deliverer by using skill information which includes one or more elements among the number of products displayed, the time required for displaying and the product display state level on the product shelf, which are calculated on the basis of an image in which the authenticated deliverer displays one or more products on a product shelf.

For example, the skill determination unit 32 executes processing relevant to the product identification unit 12 to the skill determination unit 20 in the first example embodiment.

An effect of the third example embodiment will be described. According to the third example embodiment of the present disclosure, it is possible to determine the delivery skill of the worker who delivers the product in a specific store such as a labor-saving store. The reason for this is that the authentication unit 31 authenticates the deliverer of the product, and the skill determination unit 32 determines the skill of the deliverer by using skill information which includes one or more elements among the number of products displayed, the time required for displaying and the product display state level on the product shelf, which are calculated on the basis of an image in which the authenticated deliverer displays products on a product shelf.

### Hardware Configuration

In each of the above-described example embodiments, each component of each device (delivery management device 100, headquarters server 210, and the like) indicates a block in a functional unit. Some or all of the components of each device may be implemented by a discretionary combination of a computer 500 and a program.

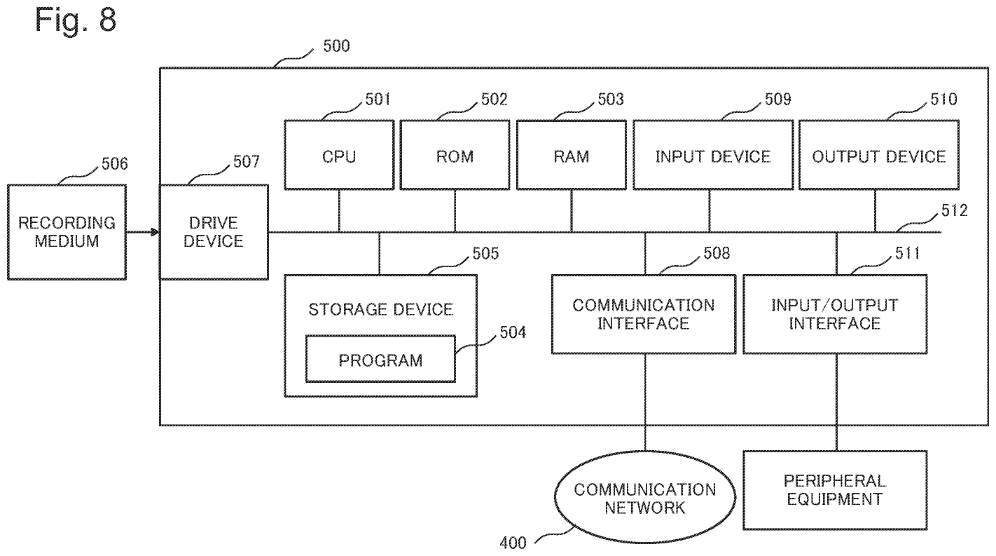

FIG. 8 is a block diagram illustrating an example of the hardware configuration of the computer 500. With reference to FIG. 8, the computer 500 includes, for example, a central processing unit (CPU) 501, a read only memory (ROM) 502, a random access memory (RAM) 503, a program 504, a storage device 505, a drive device 507, a communication interface 508, an input device 509, an output device 510, an input/output interface 511, and a bus 512.

The program 504 includes an instruction for implementing the functions of each device. The program 504 is stored in advance in the ROM 502, the RAM 503, and the storage device 505. The CPU 501 implements each function of each device by executing instructions included in the program 504. For example, by executing an instruction included in the program 504, the CPU 501 of the delivery management device 100 implements functions of the authentication unit 11, the product identification unit 12, the display count calculation unit 13, the display time calculation unit 14, the display state determination unit 15, and the like. The RAM 503 may store data to be processed in the functions of each device. For example, the RAM 503 of the delivery management device 100 may store data of the display product storage unit 18 and the skill storage unit 19.

The drive device 507 reads and writes the recording medium 506. The communication interface 508 provides an interface with a communication network. The input device 509 is, for example, a mouse, a keyboard, a touchscreen, or the like, and receives input of information from a manager or the like. The output device 510 is, for example, a display, and outputs (displays) information to the manager or the like. The input/output interface 511 provides an interface with peripheral equipment. In the case of the delivery management device 100, the above-described camera 21, the output unit 22, and the like are connected to the input/output interface 511. The bus 512 connects these components of the hardware. The program 504 may be supplied to the CPU 501 via a communication network, or may be stored in the recording medium 506 in advance, read by the drive device 507, and supplied to the CPU 501.

The hardware configuration illustrated in FIG. 8 is an example, other components may be added, and some components need not be included.

There are various modifications of the achievement method of each device. For example, each device may be achieved by a discretionary combination of a computer and a program different for each component. A plurality of components included in each device may be achieved by a discretionary combination of a computer and a program.

Some or all of the components of each device may be achieved by a general-purpose or special-purpose circuitry including a processor, or a combination of them. These circuitries may be configured by a single chip or may be configured by a plurality of chips connected via the bus. Some or all of the components of each device may be achieved by a combination of the above-described circuitry and program.

When some or all of the components of each device are achieved by a plurality of computers, circuitries, and the like, the plurality of computers, circuitries, and the like may be centralized or decentralized.

The delivery management device 100 may be arranged in each store, those other than the camera 21 may be arranged in a place different from the store 1, and the camera 21 may be connected to the delivery management device 100 via a communication network. That is, the delivery management device 100 may be implemented by a cloud computing system. Similarly, the headquarters system 200 may also be implemented by a cloud computing system.

While the disclosure has been particularly shown and described with reference to example embodiments thereof, the disclosure is not limited to these embodiments. It will be understood by those of ordinary skill in the art that various changes in form and details may be made therein without departing from the spirit and scope of the present disclosure as defined by the claims. The configurations in the example embodiments can be combined with one another without departing from the scope of the present disclosure.

### REFERENCE SIGNS LIST

1 store
1A labor-saving store (child store)
1B labor-saving store (child store)
1C labor-saving store
1D regular store (parent store)
10 inventory management system
11 authentication unit
12 product identification unit
13 display count calculation unit
14 display time calculation unit
15 display state determination unit
16 deliverer storage unit
17 product storage unit
18 display product storage unit
19 skill storage unit
20 skill determination unit
20a skill determination unit
21 camera
22 output unit
23 purchased product specification unit
24 purchase history storage unit
30 delivery management device
31 authentication unit
32 skill determination unit
100 delivery management device
100a delivery management device
200 headquarters system
210 headquarters server
500 computer

### 501 CPU

### 502 ROM

### 503 RAM

504 program
505 storage device
506 recording medium
507 drive device
508 communication interface
509 input device
510 output device
511 input/output interface
512 bus

What is claimed is:

1. A delivery management device comprising:
one or more memories storing instructions; and
one or more processors configured to execute the instructions to:
authenticate a deliverer of a product based on a captured image; and
determine a skill of the deliverer by using skill information calculated based on an image in which the deliverer having been authenticated displays one or more products on a product shelf, the skill information including one or more elements among a number of the products displayed, time required for displaying the products, and a product display state level on the product shelf.

2. The delivery management device according to claim 1, wherein the one or more processors are configured to execute the instructions to:
identify individual information of each of the displayed one or more products based on the image.

3. The delivery management device according to claim 1, wherein the one or more processors are configured to execute the instructions to:
calculate the number of the displayed one or more products based on the image.

4. The delivery management device according to claim 1, wherein the one or more processors are configured to execute the instructions to:
calculate, based on the image, time required from start to end of displaying the one or more products completed by the deliverer.

5. The delivery management device according to claim 1, wherein the one or more processors are configured to execute the instructions to:
specify an arrangement position of each of the one or more products in the product shelf based on the image, and determine a display state level of a product in the product shelf using the arrangement position having been specified.

6. The delivery management device according to claim 1, wherein the one or more processors are configured to execute the instructions to:
specify a purchased product among the displayed one or more products based on the image, and calculates a sales value of the purchased product; and
determine the skill of the deliverer based on the skill information including the sales value.

7. The delivery management device according to claim 6, wherein the one or more processors are configured to execute the instructions to:
output an image in which the one or more products are displayed on the product shelf based on the sales value.

8. The delivery management device according to claim 1, wherein
the captured image and the image in which the deliverer displays the one or more products on the product shelf are acquired from a same resource.

9. A delivery management method comprising:
authenticating a deliverer of a product based on a captured image; and
determining a skill of the deliverer by using skill information calculated based on an image in which the deliverer having been authenticated displays one or more products on a product shelf, the skill information including one or more elements among a number of the products displayed, time required for displaying the products, and a product display state level on the product shelf.

10. A storage medium that stores a program for causing a computer to execute:
authenticating a deliverer of a product based on a captured image; and
determining a skill of the deliverer by using skill information calculated based on an image in which the deliverer having been authenticated displays one or more products on a product shelf, that includes one or more elements among a number of the products displayed, time required for displaying the products, and a product display state level on the product shelf.
